(19) United States
(12) Patent Application Publication
(10) Pub. No.: US 2010/0130379 A1
(43) Pub. Date: May 27, 2010

(54) Weighted Chemiluminescent Chip array Method for Multiple Marker Detection

(75) Inventors: Shiu-Ru Lin, Kaohsiung (TW); Chung-Chi Chen, Shuilin Shiang (TW)

Correspondence Address: Yen Jung Sung, 21-80 38 St, #C8, Astoria, NY, 11105, US

(73) Assignee: FOOYIN UNIVERSITY, Kaohsiung (TW)

(21) Appl. No.: 12/604,393

(22) Filed: Oct. 23, 2009

Related U.S. Application Data
(63) Continuation-in-part of application No. 12/239,764, filed on Sep. 27, 2008, now abandoned.

(51) Int. Cl. C40B 30/04

(52) U.S. Cl. 506/9

(57) ABSTRACT

A gene chip for chemiluminescent detection is obtained. The chip uses multiple markers. Weighted scores are given to genes separately according to their influences on forming a cancer. The present invention provides an objective and accurate disease assistant diagnosis with a low cost, a high sensitivity and a good performance. The present invention can be widely applied to personal medical behaviors, like clinical diagnosis, treatment filtration, prognosis review, preventive medicine, etc.

### CROSS-REFERENCE TO RELATED APPLICATIONS

This application is a continuation-in-part of U.S. application Ser. No. 12/239,764, filed on Sep. 27, 2008, the teachings of which are incorporated herein by reference.

### FIELD OF THE INVENTION

The present invention relates to a marker chip; more particularly, relates to an operating platform for multiple-marker genetic detection by using a chemiluminescent gene chip for an objective and exact disease assistant diagnosis with a low cost, a high sensitivity and a good performance.

### DESCRIPTION OF THE RELATED ARTS

There are generally few circulating tumor cells in blood; and so it is hard to detect them. For decades, reverse transcription-polymerase chain reaction (RT-PCR) or real-time PCR are used to analyze cancer-related messenger ribonucleic acids (mRNA) in the circulating tumor cells. However, only one molecular marker is analyzed once at a time. If a set of molecular markers are used, sensitivity on detecting the circulating tumor cells may be improved yet with a lot of time and cost spent.

General detection methods include fluorescence analysis and colorimetric analysis. But the fluorescence analysis uses high-priced reagents and equipments, which prevent it from wide spread. Although the colorimetric analysis is easier, cheaper and more sensitive than the fluorescence analysis, its operation and examination may be greatly affected by human error. Moreover, no weighted scores are applied in the above prior arts to different genes according to their influences on forming a cancer. Hence, the prior arts do not fulfill all users' requests on actual use.

### SUMMARY OF THE INVENTION

The main purpose of the present invention is to provide an operating platform with a low cost, a high sensitivity and a good performance for multiple-marker genetic detection by using a chemiluminescent gene chip for an objective and exact disease assistant diagnosis through giving weighted scores to cancer-related genes according to their influences on forming a cancer.

Another purpose of the present invention is to broaden detection on multiple gene targets in circulating tumor cells through a chemiluminescent analysis having low background value with excellent sensitivity and stability.

Another purpose of the present invention is to provide a diagnosis method for medical behaviors, like clinical diagnosis, treatment filtration, prognosis review, preventive medicine, etc., which has a high sensitivity.

To achieve the above purposes, the present invention is a weighted score detection method for a chemiluminescent multiple marker chip, comprising steps of: (a) obtaining a plurality of candidate genes related to a disease to be spotted on a membrane array of polyvinylidenefluoride (PVDF), where a chemiluminescent gene chip is thus obtained with a set of negative control genes and a set of internal control genes; (b) obtaining a specimen of blood or tissue; (c) extracting ribonucleic acids (RNA) from the blood or tissue; (d) obtaining complementary deoxyribonucleic acids (cDNA) from the RNAs to be labeled for obtaining markers as probes through methods of reverse transcription and two continuous linear labeling reactions for ensuring label effect; (e) processing hybridization to the chemiluminescent gene chip and the markers; (f) processing chemiluminescent detection to the chemiluminescent gene chip with the markers after the hybridization; (g) automatically analyzing an image obtained through the chemiluminescent detection; and (h) obtaining a genetic weighted score from detection values obtained after the analyzing through giving weighted scores to the candidate genes separately according to their influences on forming the disease. Accordingly, a novel weighted score detection method for a chemiluminescent multiple marker chip is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the flow view showing the preferred embodiment according to the present invention; and

FIG. 2 is the view showing the operation of the preferred embodiment.

### DESCRIPTION OF THE PREFERRED EMBODIMENT

The following description of the preferred embodiment is provided to understand the features and the structures of the present invention.

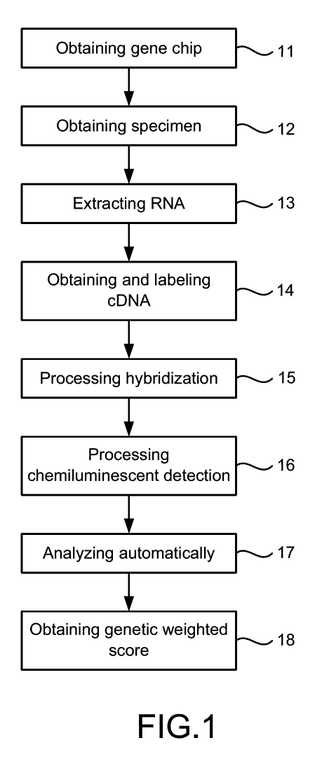

Please refer to FIG. 1, which is a flow view showing a preferred embodiment according to the present invention. As shown in the figure, the present invention is a weighted score detection method for a chemiluminescent multiple marker chip, comprising the following steps:

(a) Obtaining gene chip 11: A plurality of candidate genes related to a disease is obtained to be spotted on a membrane array of polyvinylidenefluoride (PVDF), where the disease is a cancer. A chemiluminescent gene chip is thus prepared, where a set of negative control genes and a set of internal control genes are formed on the chip.

(b) Obtaining specimen 12: A specimen of blood or tissue is obtained.

(c) Extracting RNA 13: Ribonucleic acids (RNA) are extracted from the blood or tissue.

(d) Obtaining and labeling cDNA 14: Complementary deoxyribonucleic acids (cDNA) are obtained from the RNAs through reverse transcription and two linear labeling reactions are continuously processed. Then, the cDNAs are labeled as markers to be used as probes.

(e) Processing hybridization 15: The chemiluminescent gene chip and the markers are processed through hybridization.

(f) Processing chemiluminescent detection 16: The chemiluminescent gene chip is processed through chemiluminescent detection with the markers after the hybridization.

(g) Analyzing automatically 17: An image obtained through the chemiluminescent detection is analyzed automatically.

(h) Obtaining genetic weighted score 18: Detection values are obtained after the above analysis, where the candidate genes are given with weighted scores separately according to their influences on forming the cancer. Finally, a genetic weighted score is obtained from the detection values.

With the above steps, a novel weighted score detection method for a chemiluminescent multiple marker chip is obtained. An operating platform for a chemiluminescent gene chip is processed through a multiple-marker genetic detection with a low cost, a high sensitivity and a good performance. Weighted scores are given to genes separately according to their influences on forming a cancer. Hence, a disease assistant diagnosis is provided accurately and objectively to personal medical behaviors, like clinical diagnosis, treatment filtration, prognosis review, preventive medicine, etc.

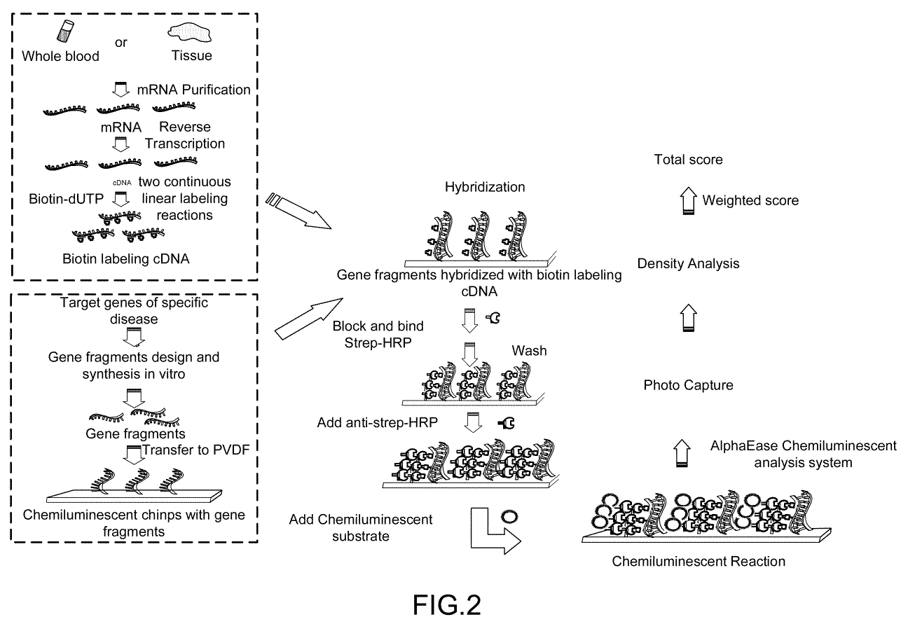

Please refer to FIG. 2, which is a view showing an operation of the preferred embodiment. As shown in the figure, candidate genes are obtained for detecting molecular markers of circulating tumor cells of breast cancer, including pituitary tumor transforming gene 1 (PTTG1), surviving, thymidine kinase 1 (TK1) and ubiquitin-carrier protein UbcH10. Mycobacterium tuberculosis is provided to obtain a set of negative control genes and β-actin is provided to obtain a set of internal control genes. The above genes are spotted on a membrane array of PVDF to obtain a chemiluminescent gene chip.

Blood specimens or tissue specimens of breast cancer are collected for extracting total RNAs. Messenger RNAs (mRNA) are extracted; and, on obtaining cDNAs through reverse transcription and two continuous linear labeling reactions, Biotin-dUTP are labeled as markers to be used as probes. Therein, dUTP linked on Biotin is re-linked to cDNA through the reverse transcription. Then, hybridization is processed to the breast cancer related candidate genes on the chemiluminescent gene chip for a chemiluminescent detection after imaging, where the hybridization is processed at 42 Celsius degrees (° C.) for 2 hours, comprising linking a streptavidin-HRP to a Biotin area on cDNA and adding an anti-streptavidin of HRP label after washing; and the chemiluminescent detection is processed for 3 minutes with a chemical luminescent base added. A real-time chemiluminescent detection system and a density analysis software are used for an automatic analysis. Detection values are thus obtained, where the cancer-related candidate genes are given with weighted scores separately according to their importance on causing the breast cancer. The total result obtained may be laid between 1 and 11, where the weighted scores of the candidate genes are as follows: PTTG1 is scored as 1; surviving is scored as 2; TK1 is scored as 4; and UbcH10 is scored as 2. The density analysis software is a gel-imaged analysis system, which can be AlphaEase® FC software, Alpha Innotech Corporation, San Leandro, Calif., USA.

In the other hand, other specimens of normal blood are collected for detection. After obtaining the weighted scores for the specimens, receiver operator characteristic (ROC) curves are obtained for analysis with a sensitivity of 92% and a specificity of 93%, where “positive” is assumed when a total score is greater than 6. Moreover, different numbers of MCF-7 breast cancer are added into the specimens of normal blood to be reacted with the chemiluminescent gene chip for analysis. As a result, it is found that sensitivity to cells in the chemiluminescent detection platform according to the present invention is 12 circulating tumor cells in a 5 milliliter (ml) blood. Hence, the chemiluminescent gene chip according to the present invention is workable and more than 5 cancer cells in 1 ml blood can be detected, where circulating tumor cells are exactly detected with the chemiluminescent gene chip.

The present invention uses a chemiluminescent analysis with a high sensitivity, a good stability and a low background to broaden detection on multiple gene targets for obtaining quantitative scores, which avoids human errors. In addition, genetic weighted scores are used on examining final results to more exactly diagnose a cancer, where different cancer-related genes are given with different weighted scores separately according to their influences on forming the cancer. Hence, the present invention is an analysis method for circulating tumor cells, where molecular markers are used for a high sensitivity and a high performance.

To sum up, the present invention is a weighted score detection method for a chemiluminescent multiple marker chip, where an operating platform for multiple-marker genetic detection with a chemiluminescent gene chip is provided with a low cost, a high sensitivity and a good performance; weighted scores are given to genes separately according to their influences on forming a cancer for an objective and exact disease assistant diagnosis; and the present invention can be widely applied to personal medical behaviors, like clinical diagnosis, treatment filtration, prognosis review, preventive medicine, etc.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A weighted score detection method for a chemiluminescent multiple marker chip, comprising steps of:
(a) obtaining a plurality of candidate genes related to a disease to be spotted on a membrane array of polyvinylidenefluoride (PVDF), where a chemiluminescent gene chip is thus obtained with a set of negative control genes and a set of internal control genes;
(b) obtaining a specimen;
(c) extracting ribonucleic acids (RNA) from said specimen;
(d) obtaining complementary deoxyribonucleic acids (cDNA) from said RNAs through methods to be labeled as markers to be used as probes, wherein said methods comprises reverse transcription and two continuous linear labeling reactions;
(e) processing hybridization to said chemiluminescent gene chip and said markers;
(f) processing chemiluminescent detection with said markers to said chemiluminescent gene chip after said hybridization;
(g) automatically analyzing an image obtained through said chemiluminescent detection; and
(h) obtaining a genetic weighted score from detection values obtained after said analyzing through giving weighted scores to said candidate genes separately.

2. The method according to claim 1,
wherein said disease is a cancer.

3. The method according to claim 1,
wherein said candidate genes comprises pituitary tumor transforming gene 1 (PTTG1), surviving, thymidine kinase 1 (TK1) and ubiquitin-carrier protein UbcH10.

4. The method according to claim 1,
wherein said negative control genes are obtained from mycobacterium tuberculosis.

5. The method according to claim 1,
wherein said internal control genes are obtained from β-actin.

6. The method according to claim 1,
wherein, in step (b), said specimen is selected from a group consisting of blood and tissue.

7. The method according to claim 1,
wherein said hybridization is processed for 2 hours.

8. The method according to claim 1,
wherein said hybridization is processed at 42° C.

9. The method according to claim 1,
wherein said chemiluminescent detection is processed for 3 minutes.

10. The method according to claim 1,
wherein, in step (g), said analyzing is processed by using a gel-imaged analysis system.
